(19) United States
(12) Patent Application Publication
(10) Pub. No.: US 2016/0193687 A1
(43) Pub. Date: Jul. 7, 2016

(54) RESISTANCE WELDING METHOD FOR SUCKER ROD

(71) Applicant: Weatherford Technology Holdings, LLC, Houston, TX (US)

(72) Inventors: Jason Robert Giebelhaus, Beaumont (CA); Hermann Basler, Stony Plain (CA)

(21) Appl. No.: 14/977,677

(22) Filed: Dec. 22, 2015

Related U.S. Application Data
(60) Provisional application No. 62/100,139, filed on Jan. 6, 2015.

(51) Int. Cl. B23K 11/02; B23K 11/31; B23K 11/30; C21D 9/08; C21D 9/50; C21D 1/40; C21D 1/613; C21D 1/767; B23K 11/24; B23K 11/00

(52) U.S. Cl. CPC B23K 11/02; B23K 11/241; B23K 11/31; B23K 11/3009; B23K 11/0073; C21D 9/505; C21D 1/40; C21D 1/613; C21D 1/767; C21D 9/085

(57) ABSTRACT

Embodiments of the present disclosure generally relate to apparatus and methods for connecting continuous sucker rods. Ends of two work pieces may be prepared by reducing cross sections of the ends. The two work pieces may be welded together by establishing a planar contact at the prepared ends and applying a current across the two work pieces while moving the work pieces relative to each other.

### CLAIM OF PRIORITY UNDER 35 U.S.C. 119

This application claims benefit of U.S. Provisional Patent Application No. 62/100,139, filed Jan. 6, 2015, and entitled “Resistance Welding Method for Sucker Rod” which is herein incorporated by reference in its entirety.

### BACKGROUND

1. Field

Embodiments of the present disclosure generally relate to apparatus for connecting continuous sucker rods.

2. Description of the Related Art

In oil and gas wells, a “drive string” connects the pump, located down hole, to the drive system, located at the surface. Sucker rods are generally used in a drive string. A conventional drive string typically includes a sequence of conventional sucker rods with connecting mechanisms at each end of each conventional sucker rod which permit end-to-end interconnection of adjacent rods. Conventional sucker rods are elongated steel rods, 20 feet to 30 feet in length. Each interconnection point between two successive conventional sucker rods is a source of potential weakness and excess wear on the adjacent tubing and casing.

Alternatively, a drive string may include one continuous sucker rod to avoid weakness caused by interconnection points between conventional sucker rods. A continuous sucker rod is a unitary rod, consisting of one elongated continuous piece of steel. Continuous sucker rod is typically produced and stored for sale on large transport reels. These transport reels have a maximum diameter of about 19 to 20 feet and the diameter may be as small as 9-10 feet. A full reel can carry continuous sucker rod with lengths of over 6,000 feet depending on the diameter of the rod. However, the length of a drive string can vary from anywhere from as little as 500 feet to as much as 10,000 feet or more, depending on the depth of the well and desired location of the pump down hole. Therefore, connections are still needed with continuous rod, for example to attach driving and/or pumping equipment, to splice lengths of rod together, to create tapered drive strings, to repair parted drive strings, or to connect the continuous sucker rod to other auxiliary components.

Welding has been the predominant method for making continuous sucker rod connections. However, continuous sucker rod connections made by traditional sucker rod welding methods, such as flash-butt welding and gas-pressure welding, have failure frequencies higher than the industry tolerance.

Therefore, there is a need for apparatus and methods for connecting continuous sucker rods.

### SUMMARY

Embodiments of the present disclosure generally relate to apparatus and methods for connecting continuous sucker rods.

One embodiment provides a welding station. The welding station includes a first clamp die adapted to secure a first work piece, a second clamp die adapted to secure a second work piece, an actuator coupled to move the first clamp die and second clamp die relative to each other, and a controller coupled to the actuator.

Another embodiment provides a method for welding continuous sucker rod. The method includes preparing ends of a first work piece and a second work piece by reducing cross sections of the ends, and welding the first work piece and the second work piece at the prepared ends.

Another method provides a method for testing a weld in a rod. The method includes bending the rod at the weld to a pre-determined angle, and examining the weld to determine the quality of the weld.

### BRIEF DESCRIPTION OF THE DRAWINGS

So that the manner in which the above recited features of the present disclosure can be understood in detail, a more particular description of the various aspects, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a schematic of a resistance-butt welding system according to one embodiment of the present disclosure.

FIG. 1B is a schematic view of a weld formed from resistance-butt welding.

FIG. 2A is a schematic sectional view of prepared abutting surfaces according to one embodiment of the present disclosure.

FIG. 2B is a schematic sectional view of work pieces during resistance-butt welding.

FIG. 2C is a schematic perspective view of prepared abutting surfaces according to one embodiment of the present disclosure.

FIG. 3 is a flow chart of a method for connecting continuous sucker rods according to one embodiment of the present disclosure.

FIG. 4 is an exemplary plot of motion, current, and quench during a resistance-butt weld according to the present disclosure.

FIG. 5 is a flow chart of a method for automated resistance-butt welding according to the present disclosure.

FIG. 6 is a plot showing operation parameters of an automated resistance-butt welding according to the present disclosure.

FIGS. 7A-7B schematically illustrates a bend performance test according to the present disclosure.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

In the following description, numerous specific details are set forth to provide a more thorough understanding of the present disclosure. However, it will be apparent to one of skill in the art that the present disclosure may be practiced without one or more of these specific details. In other instances, well-known features have not been described in order to avoid obscuring the present disclosure.

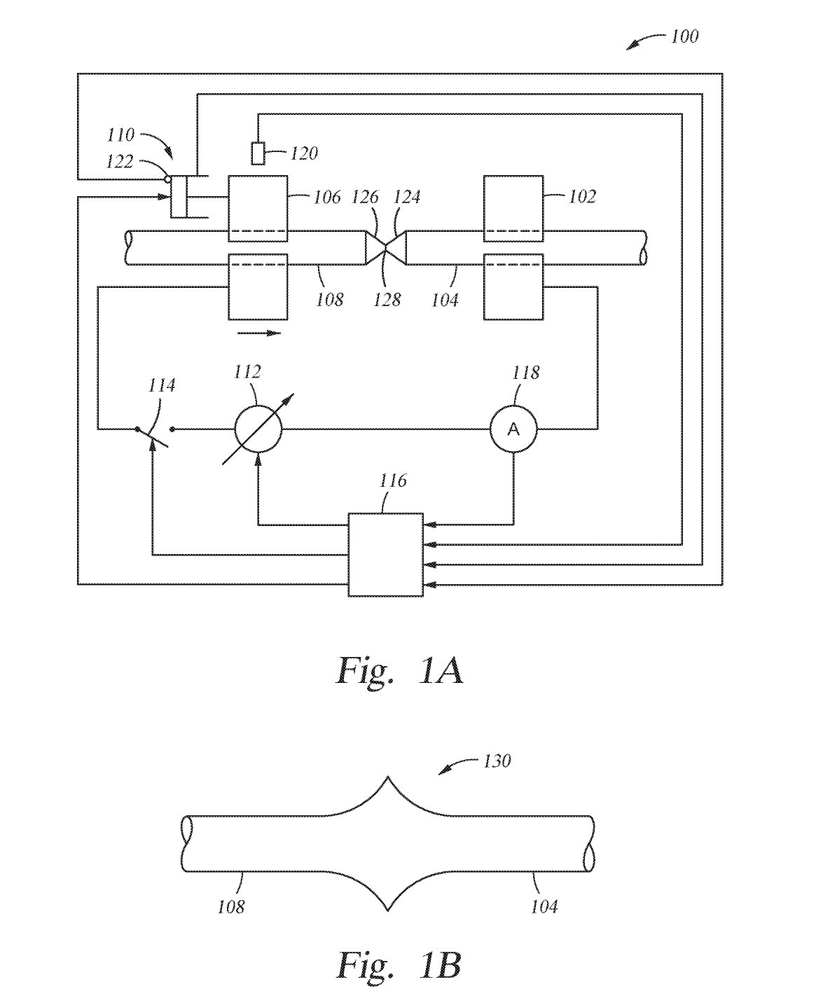

FIG. 1A is a schematic of a resistance-butt welding system 100 according to one embodiment of the present disclosure. The resistance-butt welding system 100 is configured to joining two work pieces together by abutting prepared ends of the work pieces together, applying current to heat the abutting surfaces of the work pieces, and applying contact force to join the work pieces.

The resistance-butt welding system 100 includes a fixed clamp die 102 and a movable clamp die 106. The fixed claim die 102 may secure a first work piece 104 so that an end 124 of the work piece 104 faces the movable clamp die 106. The movable clamp die 106 may secure a second work piece 108 so that an end 126 of the work piece 108 faces the fixed clamp die 102. One or both of the work pieces 104, 108 may be continuous sucker rods.

The movable clamp die 106 may be connected to an actuator 110. The actuator 110 is configured to move the movable clamp die 106 relative to the fixed clamp die 102. The movable clamp die 106 may secure and move the second work piece 108 to make contact between the work pieces 104, 108 at the ends 124, 128 and to apply force between the work pieces 104, 108. The actuator 110 may be any suitable drive mechanism. In one embodiment, the actuator 110 may be a hydraulic cylinder. It must be noted that clamp dies 102, 106 are configured to allow relative movement between the work pieces 104, 108. In one embodiment, both claim dies 102, 106 may be movable, for example, the clamp die 102 may be configured to move by a second actuator.

The resistance-butt welding system 100 further includes a power supply 112. The power supply 112 may be connected to deliver electric current across an interface 128 of the work pieces 104, 108 when the work pieces 104, 108 are in contact. In one embodiment, the power supply 112 may be coupled to the fixed clamp die 102 and the movable clamp die 106. The power supply 112 may be direct current (DC) power source or alternate current (AC) power source. In one embodiment, the power supply 112 may be adjustable to deliver variable current and/or variable voltage to the work pieces 104, 108. A switch 114 may be used to switch on and off the power supply 112.

The resistance-butt welding system 100 further includes a controller 116. The controller 116 may be connected to the actuator 110 to control the movement of the movable clamp die 106. In one embodiment, a sensor 120 may be configured to sense motion and/or location of the movable clamp die 106. The sensor 120 may be connected to the controller 116. The controller 116 may receive signals from the sensor 120 to determine the position and/or speed of the movable clamp die 106. The controller 116 may then send a command to the actuator 110 according to the determined position and/or speed information.

The controller 116 may be configured to control the power supply 112. For example, the controller 116 may control the switch 114 to turn on and off the power supply 112. In one embodiment, the power supply 112 may be adjustable. The controller 116 may adjust at least one of the current and the voltage of the power supply 112. The resistance-butt welding system 100 may include a sensor 118 connected to monitor one or more parameters of the power supply 112. The controller 116 may receive and monitor input signals of the sensor 118 and control the power supply 112, the actuator 110, or both, in response to the signal from the sensor 118. In one embodiment, the sensor 118 may be a current sensor.

The resistance-butt welding system 100 may also include additional sensors to monitor operating parameters, such as pressure, force, temperature, and combinations thereof. In one embodiment, a force sensor 122 may be connected to measure the force applied between the first and second work pieces 104, 108. The controller 116 may monitor the measurement of the force sensor 122 and control the power supply 112 and/or the movable clamp die 106. During resistance-butt welding, the size of the cross section of the contact area between the two work pieces 104, 108 changes continuously. Since the force applied between the two work pieces 104, 108 is not affected by the change in size of the contact area, the force sensor 122 provides a direct measurement for the controller 116 to control the power supply 112 and/or the movable clamp die 106. Alternatively, a pressure sensor may be used in place of a force sensor 122. The measured pressure may be used by the controller 116 to control the power supply 112 and/or the movable clamp die 106.

According to one embodiment of the present disclosure, the resistance-butt welding system 100 may be installed on the back of a truck to operate in the field. The power supply 112 may be a group of 12 Volt batteries that may be recharged. The power supply 112 may be recharged by the motor of the truck, for example from an oversized alternator of the truck, or from a hydraulic driven generator of the truck. Alternatively, the power supply 112 may be charged from an independent generator disposed on the truck or from land power when the truck is parked at the base or a location with access to land power.

Ends 124, 126 of the work pieces 104 and 108 may be prepared to improve heating uniformity during welding, avoid arcing, and reduce contamination in the weld line. In one embodiment, the ends 124, 126 of the first and second work pieces 104, 108 may be prepared to be tapered ends, wherein areas of cross sections of the work pieces 104, 108 gradually reduce from the bodies of the work pieces 104, 108 to the tips. The tapered ends 124, 126 allow a contact surface 128 that is smaller than the cross sections of the first and second work pieces 104, 108. The smaller contact surface 128 enables a more planar contact than a larger contact surface, thus, providing a more uniform heating and resulting in a uniform weld. In one embodiment, the contact surface 128 may be less than about 25% of the cross section of the work pieces 104, 108. The contact surface 128 may be between about 15% to about 25% of the cross section of the work pieces 104, 108.

During process, the tapered ends 126, 128 are pushed into each other to form a weld. FIG. 1B schematically illustrates a weld 130 resulted from the resistance-butt weld. The diameter of the weld 130 depends on the distance of the relative movement between the work pieces 104, 108. The longer the distance, the larger the diameter of the weld 130. In one embodiment, the weld 130 may have a larger diameter than the work pieces 104, 108 to obtain uniformity in the weld 130.

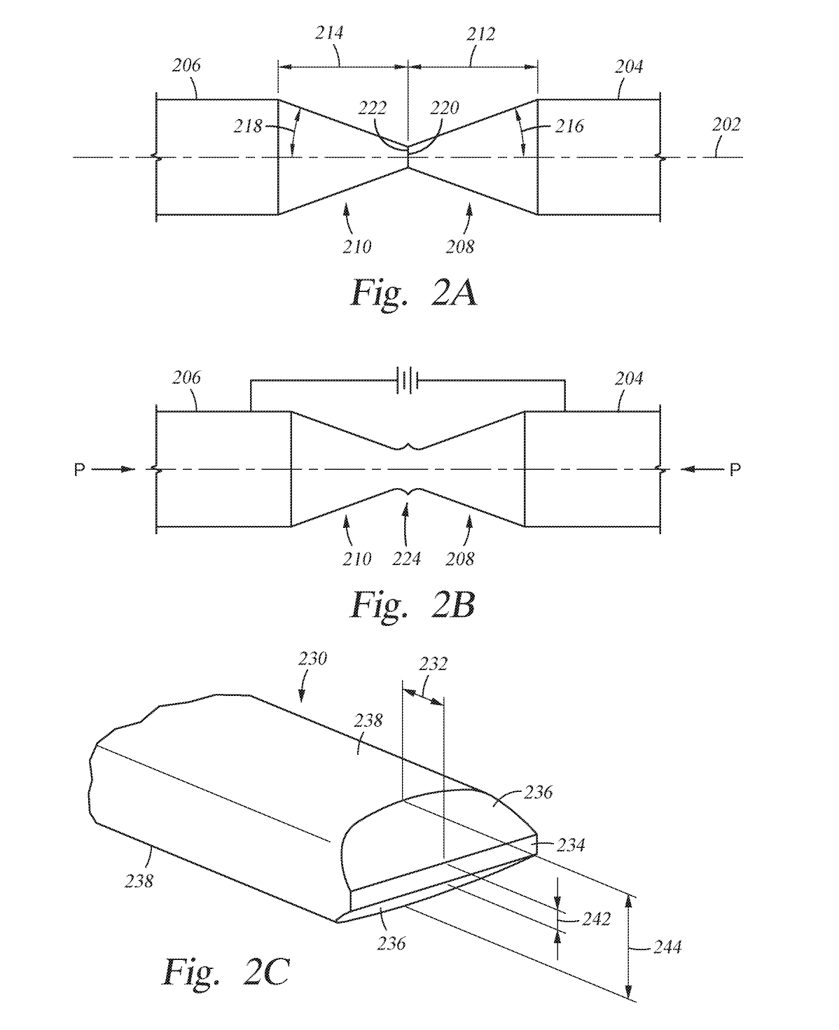

FIG. 2A is a schematic sectional view of prepared abutting surfaces according to one embodiment of the present disclosure. Two work pieces 204, 206 are prepared to be joined together by resistance-butt welding according to the present disclosure. The two work pieces 204, 206 are prepared to be joined along a longitudinal axis 202. In this embodiment, each work piece 204, 206 has been prepared to include a tapered end 208, 210 respectively. The tapered ends 208, 210 may have any suitable shape depending on the size of the work pieces 204, 206 and/or tools available. In one embodiment, the tapered ends 208, 210 may be shaped like a chisel. In another embodiment, the tapered ends 208, 210 may be conically shaped. The tapered ends 208, 210 are sized between 15% and about 25% of the cross section of the work pieces 204, 206.

The tapered ends 208, 210 may be prepared by chamfering. As shown in FIG. 2A, the tapered end 208 may be formed by chamfering the work piece 204 along an angle 216. The tapered end 208 may have a substantially planer end surface 220 to facilitate a planar contact at the beginning of welding. The tapered end 210 may be formed by chamfering the work piece 206 along an angle 218. The angle 216, 218 may be between about 30 degrees to about 45 degrees. The tapered end 210 may have a substantially planer end surface 222 for contacting the planer end surface 220 of the work piece 204. Lengths 212, 214 of the tapered ends 208, 210 may be between about 5/16 inches to about ½ inches for sucker rods having semi-elliptical cross sections. The shape and dimension of prepared ends may be different for sucker rods with other cross sections. The lengths 212, 214 of the tapered ends 208, 210 may be the same or different depending on sizes of the work pieces 204, 206. Similarly, the angles 216, 218 may be same or different. In one embodiment, the end surfaces 220, 222 may have the same shape and the same size to enable uniform heating at the beginning of resistance-butt welding.

The size of the end surfaces 220, 222 may be smaller than the cross sections of the work pieces 204, 206. In one embodiment, the size of the end surfaces 220, 222 may be less than 80% of the size of the cross section of the body of the work pieces 204, 206. In another embodiment, the size of the end surfaces 220, 222 may be between about 15% to about 25% of the size of the cross section of the body of the work pieces 204, 206. Without being bound by theory, it is believed the reduced size of the end surfaces 220, 222 eliminates air pockets between the work pieces 204, 206 when in contact, thus improving heating uniformity. The tapered ends 208, 210 allow the area of the contact surface to gradually increase during welding resulting in uniform weld. FIG. 2B is a schematic sectional view of work pieces 204, 206 during resistance-butt welding. The work pieces 204, 206 are heated and forced together causing the work pieces 204, 206 to upset and forming a weld seam 224.

Cross section of continuous sucker rods may have different shapes, for example, circular, elliptical, semi-elliptical. FIG. 2C is a schematic perspective view of prepared end on a sucker rod 230 according to one embodiment of the present disclosure. The sucker rod 230 has a semi-elliptical cross section with two wide sides 238. Slanting surfaces 236 may be formed from the wide sides 238 towards the tip. An abutting surface 234 is formed at the tip. The abutting surface 234 connects to the slanting surfaces 236. The abutting surface 234 may be a substantially planar surface, which facilitate a planar contact with an abutting surface of another sucker rod to be welded together. The area of the abutting surface 234 is substantially smaller than the cross sectional area of the sucker rod 230. Reduced size of the abutting surface 234 facilitates current uniformity during welding. The size of the abutting surface 234 may be set to be as small as possible while still avoiding melting of the prepared ends at the beginning of weld. In one embodiment, a height 242 of the abutting surface 234 may be between about 10% and 20% of a height 244 of the sucker rod 230. In one embodiment, the height 242 of the abutting surface 234 may be about one eighth of an inch for a semi-elliptical sucker rod has a height of 1 inch. In one embodiment, the height 242 of the abutting surface 234 may be about one tenth of an inch for a semi-elliptical sucker rod has a height of 1 inch. The slanting surfaces 236 and the abutting surface 234 may be prepared manually or by machine. In one embodiment, the slanting surfaces 236 and the abutting surface 234 may be prepared by chamfering.

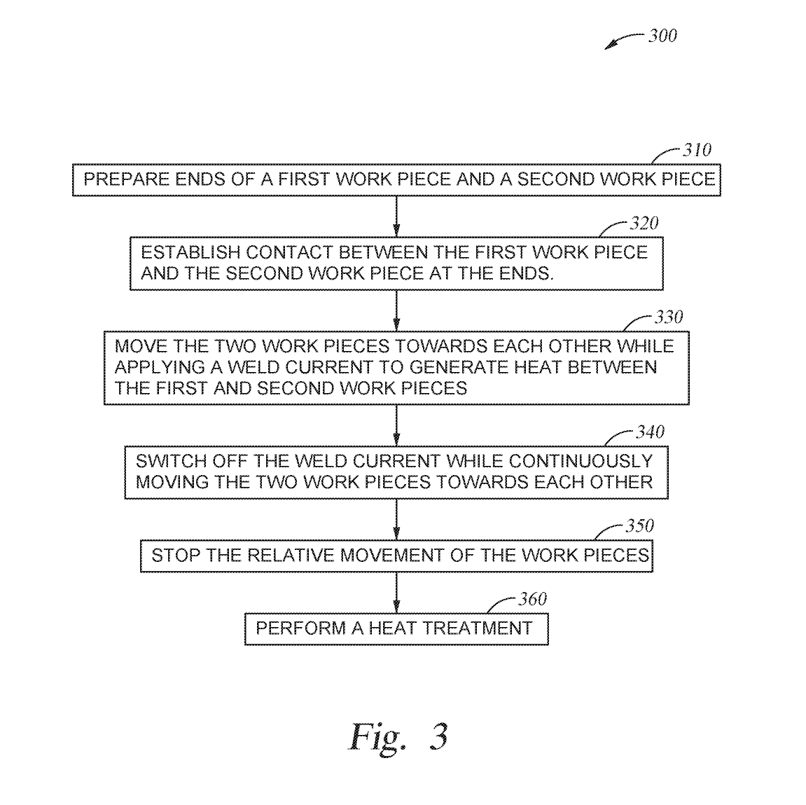

FIG. 3 is a flow chart of a method 300 for connecting two work pieces together according to one embodiment of the present disclosure. The method 300 may be used to connect two sucker rods to form a continuous sucker rod. The method 300 may be performed by the resistance-butt welding system 100 of the present disclosure.

Box 310 of the method 300 includes preparing the ends of the two work pieces to be connected. For example, the ends of the work pieces may be prepared to include a gradually increased sectional area so that the contact areas of the two work pieces increase during the course of butt welding. In one embodiment, preparing the ends includes forming an abutting surface on a tip of the end of each work pieces. The abutting surfaces may be planar to enable a planar contact between the two work pieces, thus, avoid arc between the work pieces when electrical power is applied to the two work pieces. The ends of the work pieces may be prepared as shown in FIGS. 2A-2C.

Box 320 of the method 300 includes positioning the first and second work pieces to establish contact at the prepared ends of the two work pieces. In one embodiment, the first and second work pieces may be secured to a stationary clamp die and a movable clamp die respectively, such as the first clamp die 102 and the second clamp die 106 of the resistive-butt welding system 100. A planar contact between the ends of the two work pieces may be established by moving the movable clamp die towards the stationary clamp die. The first and second work pieces may be in planar contact at the abutting surfaces and aligned axially.

Box 330 of the method 300 includes applying a weld current across the first and second work pieces to generate a resistive heat at the abutting ends. The weld current may be applied by switching on a power source 116 of the resistive-butt welding system 100 that is connected to the clamp dies in which the work pieces are secured. The weld current may be direct current (DC) or alternating current. In one embodiment, the weld current may be applied by applying a constant voltage between the two work pieces. The planar contact at the abutting surfaces of the prepared ends of the work pieces prevents any arc or flashing from occurring between the work pieces and to maintain a minimum contact force between the work pieces when the weld current is applied. When the weld current is applied, the electrical resistance at the interface of the two work pieces causes heat to generate at the interface. In one embodiment, the weld current is tailored to generate enough heat to soften but not melt the prepared ends of the work pieces.

In one embodiment, a force is applied to urge the work pieces towards each other while applying the current. As the heat from the weld current softens the prepared ends of the work pieces, the force moves the work pieces into each other whereby the prepared ends upset. Because the prepared ends have gradually increased cross sections, the area of cross section at the interface of the two work pieces increases as the two work pieces move towards each other. The force may be applied using any suitable devices. In one embodiment, the force may be applied by an actuator, such as the actuator 110, coupled to the movable clamp die to which one of the work piece is secured.

Without being bound by theory, it is believed the small contact area at the beginning of applying the weld current allows uniform current distribution across the abutting surfaces. The gradual increase of the contact area helps maintain the uniform current distribution, thus resulting in a high quality weld.

Box 340 of the method 300 includes ceasing or reducing the weld current while continuously moving the two work pieces towards each other to form the weld. In one embodiment, the weld current may cease when the interface of the work pieces reaches a desired temperature such that no additional heat is needed to complete the welding process.

Box 350 of the method 300 includes stopping movement of the work pieces. As the work pieces are moved towards each other, the contact area between the ends increases. The movement of the work pieces may be stopped at a predetermined time, at a predetermined load, at a predetermined contact force, or at a predetermined contact pressure.

Box 360 of the method 300 includes performing a heat treatment to the weld. While the work pieces move to form the weld, microstructures in the ends of the work pieces may be disrupted. A heat treatment may be performed on the weld to achieve desired mechanical properties in the weld. In one embodiment, a heat treatment current is applied for a short period of time. The heat treatment current may be applied by switching on a power source that is connected to the clamp dies, such as the power source 116 of the resistive-butt welding system 100. The heat treatment current may be direct current (DC) or alternating current (AC). In one embodiment, the heat treatment current may be applied by applying a constant voltage between the two work pieces. In one embodiment, the weld may be quenched after the heat treatment current is applied. For example, high pressure gas quenching may be applied after the heat treatment supply. In one embodiment, a gas pressure between about 15 psi to about 20 psi may be applied to perform high pressure gas quenching. In one embodiment, a gas pressure between about 20 psi to about 25 psi may be applied to perform high pressure gas quenching. In one embodiment, a gas pressure between about 50 psi to about 60 psi may be applied to perform high pressure gas quenching. In one embodiment, a gas pressure between about 65 psi to about 75 psi may be applied to perform high pressure gas quenching.

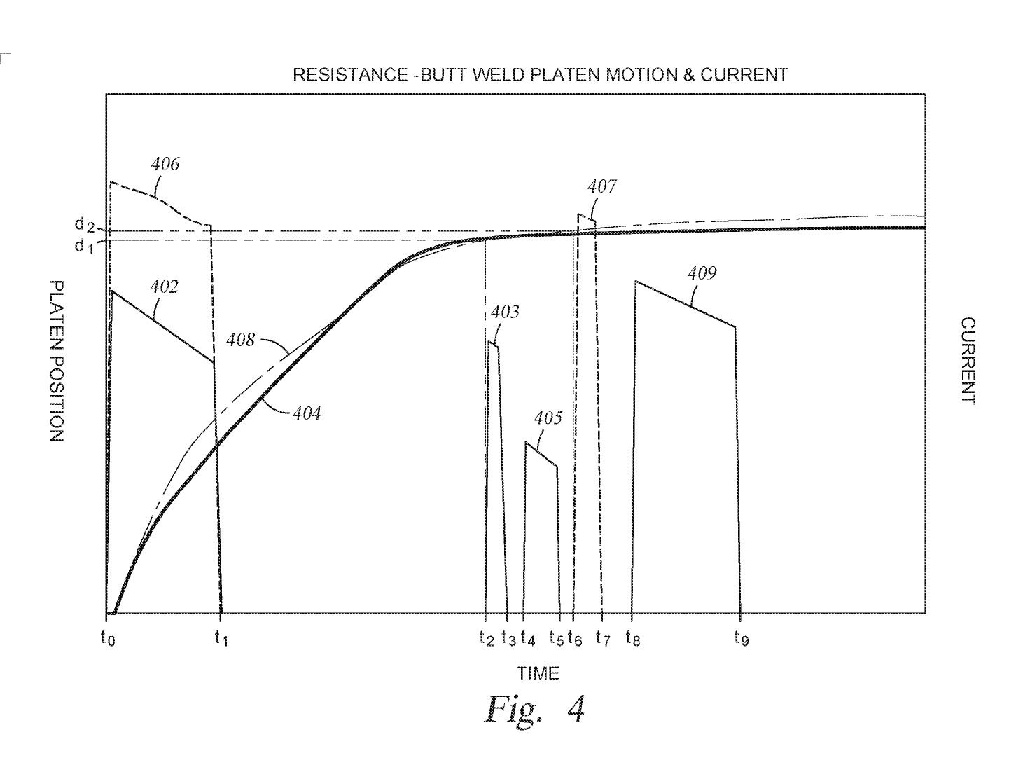

FIG. 4 are graphs of motion, current, and quench over time of two exemplary resistance-butt weld processes according to the method 300. In these exemplary processes, the ends of the two sucker rods are prepared, then the first sucker rod is secured to a stationary clamp die and the second sucker rod is secured to a movable clamp die so that the second sucker rod may be moved towards the first sucker rod. After the ends contact, current is applied according to the method 300.

In FIG. 4, lines 402, 403, 404, 405 relate to a first set of sucker rods. Line 402 shows the weld current applied across the two sucker rods over time. Line 403 shows the heat treatment current applied to the sucker rods. Line 404 shows the position of the second sucker rod over time. Line 405 shows the gas pressure applied during high pressure gas quenching. Between time t₀ to t₁, a welding current is applied as the second sucker rod moves toward the first sucker rod. Between time t₁ and t₂, the weld current is switched off as the second sucker rod continues to move to and reaches distance d₁. During the time between t₂ and t₃, a heat treatment current is applied while the second sucker rod remains substantially stationary. During the time t₃ and t₄, a high pressure gas is applied to the weld to quench the weld.

The lines 406, 407, 408, and 409 relate to a second set of sucker rods that are thicker than the first set of sucker rods. Line 406 shows the current applied across the two sucker rods over time. Line 407 shows the heat treatment current applied to the sucker rods. Line 408 shows the position of the second sucker rod over time. Line 409 shows the gas pressure applied during high pressure gas quenching. Between time t₀ to t₁, a welding current is applied as the second sucker rod moves toward the first sucker rod. The weld current for the second set of sucker rods is higher than the weld current for the first set of sucker rods. Between time t₁ and t₆, the weld current is switched off while the second sucker rod continues to move and reaches distance d₂. During the time between t₆ and t₇, a heat treatment current is applied while the second sucker rod remains substantially stationary. During the time t₈ and t₉, a high pressure gas is applied to the weld to quench the weld.

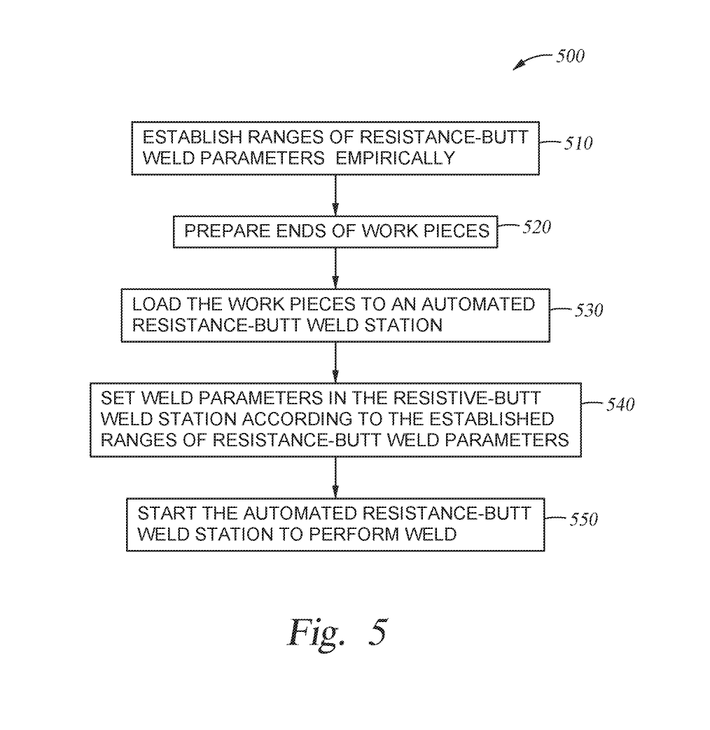

The resistance-butt welding may be performed manually and the parameters may be controlled by operator's in response to observation. In one embodiment, the resistance-butt welding may be automatically controlled to achieve repeatable quality. FIG. 5 is a flow chart of a method 500 for automated resistance-butt welding according to the present disclosure. The method 500 may be performed using resistance-butt weld system 100. The automated weld process improves quality of the welding by eliminating human errors.

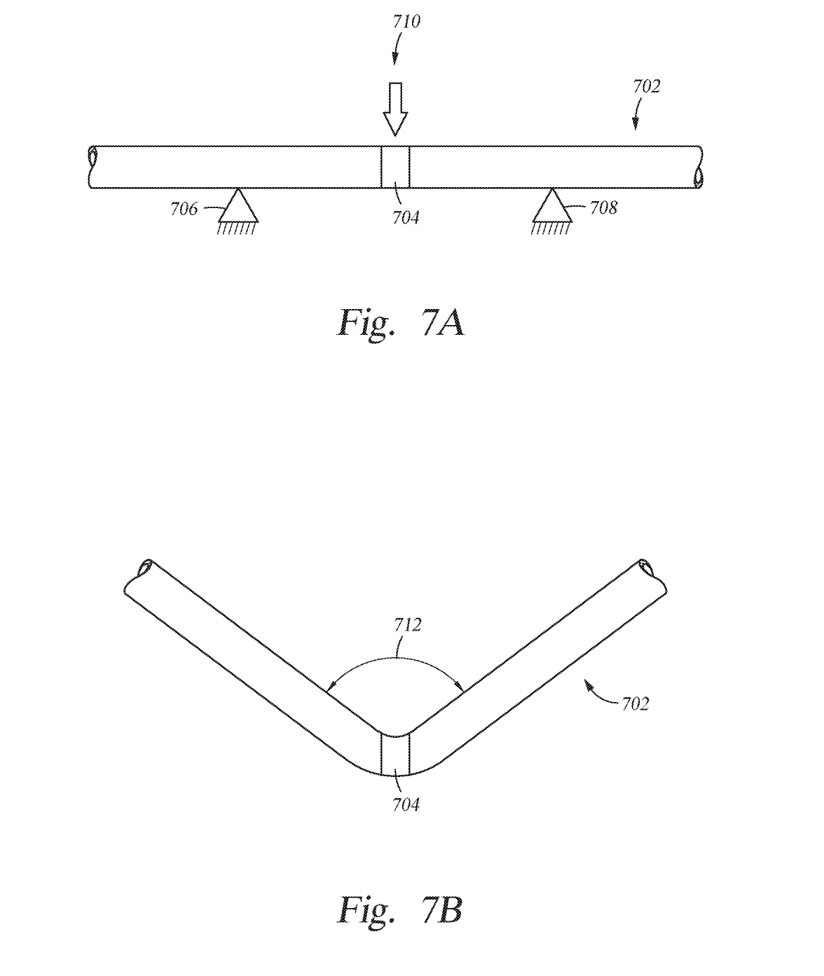

Box 510 of the method 500 includes establishing ranges of parameters empirically. The parameters may include one or more of value and duration of the weld current, speed and distance of movable sucker rod, and timing, duration and value of the heat treatment current. For each setting, such as a combination of size, shape, and material of sucker rods, ranges of parameters may be established by conducting resistance-butt welding under various process parameters and performing a test to determine whether the process parameters yield an acceptable weld. In one embodiment, a bend test (to be discussed with FIGS. 7A-7D) may be performed. Alternatively, other suitable tests, such as tensile strength test, may be used according to the requirement for the welding. The established ranges of parameters may be stored in a computer storage medium. In one embodiment, the established ranges of parameters may be stored in the system controller 116 of the resistance-butt weld system 100.

Box 520 of the method 500 includes preparing ends of work pieces to be welded together. Box 520 may be similar to Box 310 of the method 300. In one embodiment, the size, shape and dimension of prepared ends may be prepared according to empirical tests.

Box 530 of the method 500 includes loading the prepared work piece onto an automatic resistance-butt weld station, such as the resistance-butt weld system 100.

Box 540 of the method 500 includes setting weld parameters according to the established range of parameters. In one embodiment, the parameters may be set by selecting size and shape of the work pieces in a controller which determines the parameters according to stored ranges of parameters.

Box 550 of the method 500 includes starting the automatic weld station to perform the resistance-butt weld, for example, from box 320 to box 350, automatically. The welding process may be completed in less than one minute, for example about 30 seconds.

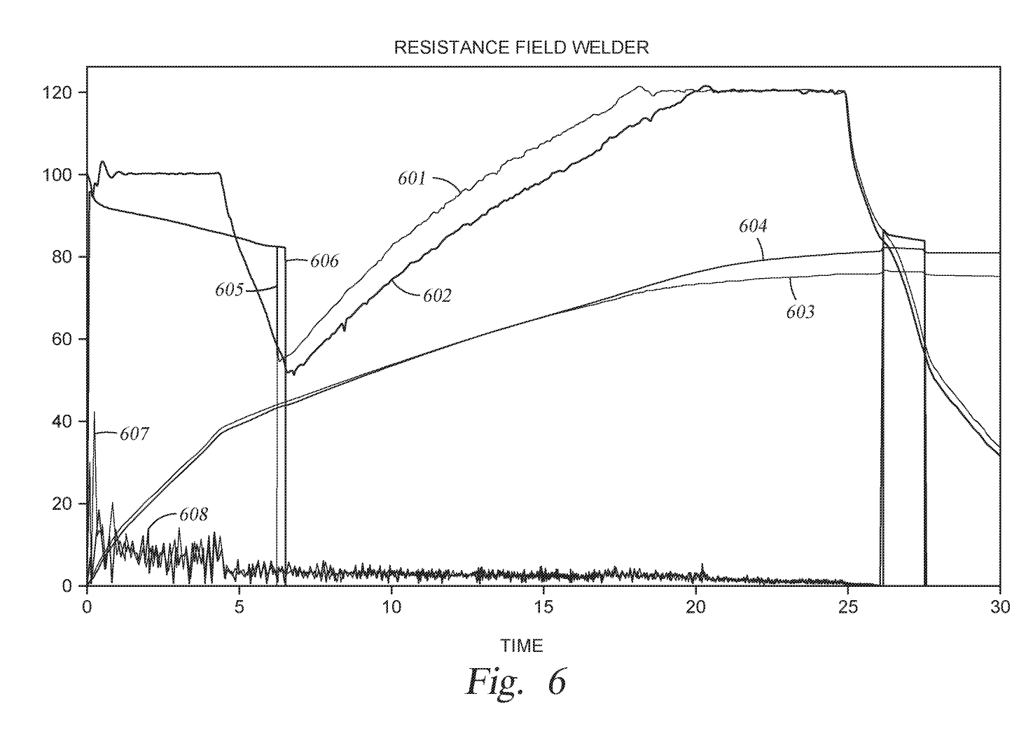

The automatic weld may be performed by monitoring and controlling various parameters, such as force, distance, current, and speed. The parameters may be measured by corresponding sensors and monitored by a controller to achieve a closed loop control. FIG. 6 is a plot showing operation parameters of an automated resistance-butt welding compared to reference measurements. Lines 601, 603, 605, 607 are time plots of force, position, current, and speed over time respectively measured during a reference resistance-butt welding. During an automated resistance-butt welding, parameters are set to repeat the performance of the reference resistance-butt welding. Lines 602, 604, 606, 608 are time plots of force, position, current, and speed respectively measured during the automated resistance-butt welding.

Embodiments of the present disclosure provide a bend performance test to detect weld line defects. Traditional tensile performance tests are performed to determine whether a weld line in a continuous sucker rod is defective. However, traditional tensile performance tests are inefficient for investigating weld line defects.

FIGS. 7A-7B schematically illustrates a bend performance test according to the present disclosure. A work piece 702 having a weld line 710 may be supported by two stationary supports 706 and 708. The weld line 710 is positioned between the two stationary supports 706 and 708. A force 710 is then applied to the work piece 702 at the weld line 704. The force 710 may be increased to bend the work piece 702 at the weld line 710 and form an angle 712. The force 710 may be applied until the angle 712 reaches a predetermined value. The bent work piece 702 may be examined to determine whether the weld has defects. For example, the bent work piece 702 will be examined to detect ductile tearing and/or rapid brittle failures. In one embodiment of the bend perform test, the work piece may be bent to an angle greater than a maximal angle that the work piece 702 is to sustain during service. In one embodiment, the work piece may be bent to between about 0 degrees to about 90 degrees in the bend performance test. The bend performance test may be used to test weld lines to establishing range of weld parameters empirically.

Embodiments of the present application may include a method for testing a weld in a rod. The method may include bending the rod at the weld to a pre-determined angle, and examining the weld to determine the quality of the weld.

In one embodiment, the per-determined angle is about 90 degrees.

In one embodiment, examining the weld includes examining presence of ductile tearing.

In another embodiment, examining the weld includes examining presence of rapid brittle failure.

In one embodiment, the method further includes forming the weld by preparing ends of a first work piece and a second work piece by reducing cross sections of the ends, and welding the first work piece and the second work piece at the prepared ends.

While the foregoing is directed to embodiments of the present disclosure, other and further embodiments may be devised without departing from the basic scope thereof, and the scope thereof is determined by the claims that follow.

1. A welding station, comprising:
a first clamp die adapted to secure a first work piece;
a second clamp die adapted to secure a second work piece;
an actuator coupled to move the first clamp die and second clamp die relative to each other; and
a controller coupled to the actuator.

2. The weld station of claim 1, further comprising:
a power supply coupled to the first clamp die and the second clamp die, wherein the controller is connected to the power supply.

3. The weld station of claim 1, wherein the first clamp die is stationary, the second clamp die is movable relative to the first clamp die, and the actuator is coupled to the second clamp die.

4. The weld station of claim 3, wherein the actuator comprises a hydraulic cylinder.

5. The weld station of claim 3, further comprising a position sensor adapted to measure position of the second clamp.

6. The weld station of claim 3, further comprising a force sensor.

7. The weld station of claim 1, wherein the controller comprises a storage unit having ranges of parameters stored therein.

8. The weld station of claim 2, wherein the power supply comprises a plurality of batteries.

9. The weld station of claim 2, wherein the current is applied across the first work piece and the second work piece.

10. A method for welding continuous sucker rods, comprising:
preparing ends of a first work piece and a second work piece by reducing cross sections of the ends; and
welding the first work piece and the second work piece at the prepared ends.

11. The method of claim 10, wherein welding the first work piece and the second work piece comprises:
applying a weld current across the first work piece and the second work piece; and
moving the first work piece and the second work piece towards each other to form an upset at the prepared ends.

12. The method of claim 11, further comprising:
positioning the first work piece and second work piece to establish contact at the prepared ends prior to applying a current across the first and second work pieces.

13. The method of claim 11, further comprising:
ceasing the weld current while continuously moving the first and second work pieces towards each other.

14. The method of claim 13, further comprising:
stopping the first work piece and/or the second work piece at a predetermined time, a predetermined contact force, or a predetermined position.

15. The method of claim 10, wherein preparing ends of the first and second work pieces comprises forming an abutting surface on the end of each of the first and second work pieces.

16. The method of claim 10, wherein preparing ends of the first and second work pieces comprises chamfering the first and second work pieces.

17. The method of claim 10, further comprising performing a heat treatment.

18. The method of claim 17, wherein performing the heat treatment comprises applying a heat treatment current across the first and second work pieces.

19. The method of claim 10, wherein welding the first work piece and the second work performed automatically.

20. A method for forming continuous rods, comprising:
positioning a first work piece and a second work piece to establish contact at ends of the first and second work pieces; and then
applying a weld current across the first work piece and the second work piece; and
moving the first work piece and the second work piece towards each other to form an upset at the prepared ends.
